(19) United States
(12) Patent Application Publication
(10) Pub. No.: US 2017/0003839 A1
(43) Pub. Date: Jan. 5, 2017

(54) MULTIFUNCTIONAL OPERATING DEVICE AND METHOD FOR OPERATING A MULTIFUNCTIONAL OPERATING DEVICE

(71) Applicant: Alexander Van Laack, Aachen (GE)

(72) Inventor: Alexander Van Laack, Aachen (GE)

(21) Appl. No.: 15/200,605

(22) Filed: Jul. 1, 2016

(30) Foreign Application Priority Data
Jul. 3, 2015 (GE) 10 2015 110764 3

(51) Int. Cl. G06F 3/0482; G07C 5/08; B60R 16/023; G06F 3/0488

(52) U.S. Cl. CPC G06F 3/0482; G06F 3/04883; G07C 5/0825; B60R 16/023; G06F 2203/04806

(57) ABSTRACT

The invention relates to a multifunctional operating device comprising a display unit (4) for displaying a menu structure, having a touchscreen or having a touchpad, wherein, within the menu structure, fields (2) are defined, which can be selected by touching, and the fields (2) are associated with defined function groups or functions, wherein the menu structure has a plurality of planes (3), and, by means of a zooming-in motion (8) with at least two fingers on a field (2) in the menu structure, another plane (3) of the menu structure can be selected, and the previous plane (1, 3) can be reached by a zooming-out motion (6).

### CROSS-REFERENCE TO RELATED APPLICATION

This patent application claims priority to German Patent Application No. DE 10 2015 110764 3, filed Jul. 3, 2015, entitled “MULTIFUNCTIONAL OPERATING DEVICE AND METHOD FOR OPERATING A MULTIFUNCTIONAL OPERATING DEVICE,” the entire disclosure of the application being considered part of the disclosure of this application and hereby incorporated by reference.

### BACKGROUND

Graphic user interfaces (GUI) are used both in the consumer electronics sector and in the automobile sector. Due to the increase in operating options, the need to display individual operating functions as clearly as possible on a display unit is also increasing. In particular, in vehicles, in which a user interface (UI) is used to inform the driver/user about (vehicle) parameters such as, for example, the speed of the vehicle, the rotational speed of the engine, or the engine temperature, and at the same time to enable the driver/user to operate apparatuses in the vehicle such as radio, CD player or navigation system, it is necessary for the operating fields to be arranged clearly, so as not to distract the driver from the actual driving of the vehicle.

### SUMMARY

The invention relates to a multifunctional operating device comprising a display unit for displaying a menu structure, having a touchscreen or touchpad, wherein, within the menu structure, fields are defined, which can be selected by touching, and the fields are associated with defined function groups or functions.

The invention further relates to a method for operating a multifunctional operating device comprising a display unit for displaying a menu structure, having a touchscreen or touchpad, wherein, within the menu structure, fields are defined, which are selected by touching, wherein defined functional groups or functions are associated with the fields, and the menu structure comprises a plurality of planes.

The invention moreover relates to a use of the multifunctional operating device and of the method.

The object of the invention accordingly consists in creating a possibility for displaying a plurality of operating fields on a display unit in the clearest way possible for a user.

The object of the present invention is achieved by a multifunctional operating device of the type described at the beginning, in which the menu structure has a plurality of planes, and in which, by means of a zooming-in motion with at least two fingers on a field in the menu structure, another plane of the menu structure can be selected, and by means of a zooming-out motion, the previous plane can be reached again. Such a menu structure in different planes has the advantage that only the respective fields relevant for the user are displayed.

The first menu structure preferably forms a principal plane with fields, wherein the fields represent higher-level function areas or functions, and the other planes represent sub-planes that provide a larger selection or particular function areas or functions.

The fields of the menu structure are designed as operating fields or as information fields. By means of the operating fields, the user can operate apparatuses that are connected to the operating device. The information fields are used for displaying information for the user. However, other embodiments are also conceivable, in which the fields are designed both as information field and as operating field.

Such a multifunctional operating device has multiple advantages, such as allowing intuitive interaction with complex systems. The menu structure of the operating device (HMI MAP) can be expanded endlessly and thus offers the possibility of adding any number of applications (apps) and functionalities. Especially in view of the Internet of Things, it offers a tremendous advantage. In addition, the operating device is ecologically and economically advantageous, since a plurality of individual apparatuses can be combined in one apparatus, which results in a savings in terms of space during installation.

In a preferred embodiment of the invention, the principal plane can be selected from any sub-plane by means of a defined closing gesture with the fingers of the user or by selecting a particular function field. This has the advantage that the user does not need to get from one plane to the respective next higher-level plane by means of a zooming-out motion in order to finally reach the principal plane (uppermost plane/overview plane) of the menu structure, instead the user may reach the principal plane directly by means of a predefined gesture such as, for example, touching with five fingers or by touching a specific field.

The fields of the menu structure within a plane can preferably be shifted by moving a finger of the user on the display unit surface. As a result, it becomes possible to display only some of the fields of the menu structure in a plane of a menu structure, as a result of which the fields can be displayed as larger with the same space requirement of the touchscreen of the operating device. In order to switch to a different field in the same plane of the menu structure, the field can be pushed away, as a result of which another field appears or is moved into the center. In the process, the fields can either be shifted in any direction or are limited to certain directions such as upward/downward (vertical) or to the left/right (horizontal).

Moreover, the object of the present invention is achieved by a method of the type described at the beginning, in which, by means of a zooming-in motion with at least two fingers on a field in the menu structure, another plane of the menu structure is opened, and, by means of a zooming-out motion, the menu structure of this plane is closed, and the previous plane is reached again.

The menu structure consists of fields that are arranged in table form or distributed on the display unit. The fields can represent information or can be used as an operating element for additional apparatuses.

The arrangement in different planes has the advantage that only the fields that are most important for the user or fields that represent higher-level functions are displayed to the user. In this manner, only a selection of fields that is relevant to the user is displayed to him/her, as a result of which the screen display remains clear.

In order to call up other operating fields or information fields, the user selects the field of interest to him/her and, by means of a zooming-in motion, reaches another plane of the menu structure that likewise contains several fields.

The zooming-in motion is a so-called pinch gesture, in which the fingertips of at least two fingers (for example, the thumb and the index finger) are moved apart from one another on the selected field of the touchscreen. In the zooming-out motion, the fingertips are moved towards one another.

In a preferred embodiment of the invention, by means of a defined closing gesture which the user performs with his/her fingers, or by the operation of a particular function field by the user, a switch takes place from any lower plane of the menu structure into the uppermost plane of the menu structure, as a result of which a more rapid navigation through the individual planes is made possible.

Moreover, the object of the present invention is achieved by a use of the multifunctional operating device and of the method for operating electronic devices of a vehicle, in particular of motor vehicles, and for displaying vehicle parameters. Particularly when steering a vehicle such as a motor vehicle, it is helpful if the driver is not distracted from driving by the operation of additional apparatuses or by reading information about vehicle parameters.

Preferably, the electronic devices can be selected from the group comprising air conditioning apparatuses, infotainment systems such as radio, CD player or video player, driver assistance systems such as navigation systems, longitudinal guidance systems or lane-keeping systems, communication systems such as mobile phones, and lighting systems.

Preferably, the vehicle parameters can be selected from the group comprising vehicle speed, engine temperature, rotational speed of the engine, settings of an infotainment apparatus such as the volume of a radio/CD player/video apparatus, the station set on the radio, the oil level, odometer reading, and other information relevant for the driver.

### BRIEF DESCRIPTION OF THE DRAWINGS

Additional details, features and advantages of designs of the invention result from the following description of embodiment examples in reference to the associated figures. The individual figures show:

FIG. 1: a diagrammatic representation of a menu structure in three planes,

FIG. 2: an exemplary representation of a user interface (UI) having a menu structure with different fields,

FIG. 3: a diagrammatic representation of a principal plane and a selected entertainment area,

FIG. 4: a diagrammatic representation of a lower-level plane and fields selected by zooming in,

FIG. 5: a diagrammatic representation of a field of the menu structure and a higher plane selected by zooming out,

FIG. 6: a diagrammatic representation of a field of a menu structure of a lower-level plane and a principal plane selected by a complete hand gesture, and

FIG. 7: a diagrammatic representation of hand gestures and the functions thereof.

### DETAILED DESCRIPTION

The multifunctional operating device is used in all fields that have a graphic user interface, also referred to as GUI, by means of which a user interacts with a system. The main fields are the automobile sector and the consumer electronics sector.

The multifunctional operating device provides a graphic user interface that can be operated via gestures. By using zooming-in motions with the fingertips (zoom in) and zooming-out motions (zoom out), also referred to as “pinch gestures”, the content of the graphic user interface can be determined and changed.

In the multifunctional operating device, the degree of detail of the displayed menu structure is controlled by means of zoom gestures. Due to the complexity of available user interfaces, users frequently look to use the user interfaces in detail. By the implementation of zoom gestures, each user can, at any time and at any site on the user interface, return to a higher-level view by means of the zooming-out motion (zoom-out gesture), and can thus find their way more easily.

On the software side, this can be understood to mean that the individual function areas, in the following also referred to as fields, are modules that can be added or removed. This can be the case, for example, if a mobile apparatus such as a mobile phone, for example, is coupled to the multifunctional operating device. Thus, when the mobile apparatus is connected to the multifunctional operating device, the usable functions are displayed on a display unit of the operating device, particularly in relation to the zoom level. For new infotainment platforms, a user interface designed in this way has the enormous advantage of flexible expansion using standard interaction modes.

To be able to connect mobile apparatuses to the multifunctional operating device, the operating device has corresponding interfaces for the connection of such mobile apparatuses. However, the mobile apparatuses can also be connected to the operating device via a WLAN connection or via a Bluetooth connection.

In the multifunctional operating device, it is possible to substantially dispense with navigation through individual menu structures by clicking, since an intuitive operation by zooming in and zooming out is made possible, as a result of which an operation via menu structures across planes becomes possible.

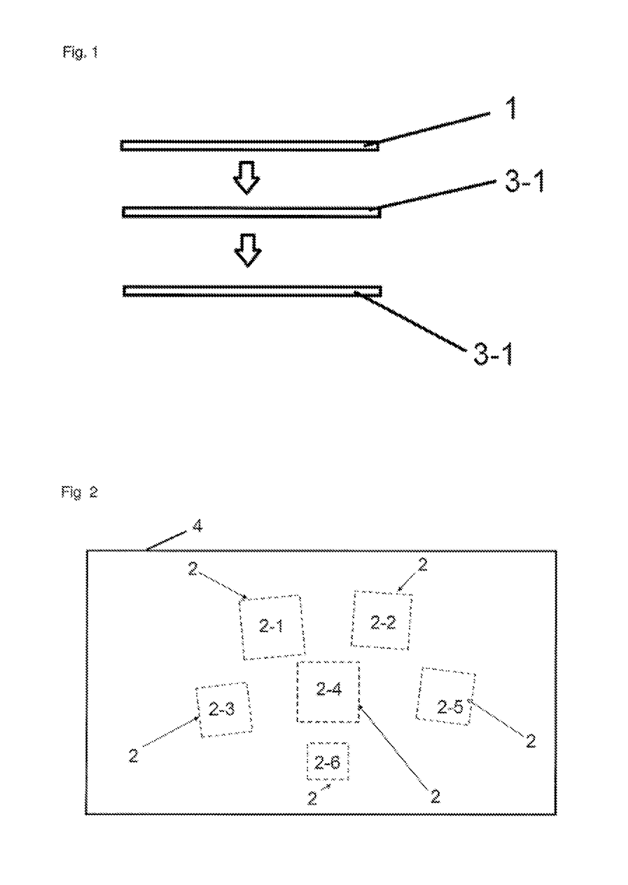

Such a three-dimensional menu structure is represented diagrammatically in FIG. 1. The menu structure consists of a principal plane 1 in which fields 2, as shown in FIGS. 2 to 6, are displayed. By zooming with a pinch gesture on the desired field 2, a lower-level plane 3-1 is reached, in which a menu structure with fields 2 is likewise displayed. To select a particular for example, on the CD player of the motor vehicle, the user first looks for the field 2 representing music on the principal plane 1, and then he/she zooms into the field 2 that represents music with a zooming-in motion (zoom in) on a lower-level plane 3-1. The lower-level plane 3.1 in turn contains a selection of fields 2 representing the different albums 2-8 or the different music performers. By another zooming-in motion on a field 2 that represents a certain performer, for example, the user reaches another lower-level plane 3-1 with a menu structure in which fields 2 with the individual music titles of the performer are displayed. By clicking on one of the fields 2 of the individual music titles, the corresponding music is played.

The menu structure can extend across any number of planes 3.

To select a different music title, the user can return to the next higher plane 3 by a zooming-out motion (zoom out). To select, use and operate a different apparatus, the user can return to the principal plane 1 by a closing gesture 7, as shown in FIG. 7, for example by placing all the fingertips on the touchscreen or on the touchpad and by a zooming-out motion.

FIG. 2 shows a possible display format of the menu structure with different fields 2 on a display unit 4. The individual fields 2 here can represent vehicle information 2-1, entertainment 2-2, communication 2-3, favorites 2-4, information 2-5, and social networks 2-6. In FIG. 2, the menu structure is represented, for example, as a (earth) globe which can be rotated by swiping the touchscreen or a touchpad, in order to display additional fields 2.

In FIG. 3, another embodiment of the menu structure is represented diagrammatically, in which the principal plane 1 is designed not as a (earth) globe as in FIG. 2, but as flat and two-dimensional. The fields 2 indicate the function of the field 2, but may also contain additional information. The field 2 containing vehicle information 2-1, for example, may also indicate gasoline consumption, and the field 2 for entertainment 2-2 may additionally display information about the music title that is currently being played.

By a zooming-in motion 8, according to FIG. 7, or by touching/clicking 5 on a field 2 of the principal plane 1, the user reaches a lower-level plane 3-1, which contains detailed information about the higher-level field 2. Thus, for example, by zooming into the field 2 image entertainment 2-2, the user reaches a lower-level plane 3-1 containing fields 2 with images 2-7, albums 2-8, radio 2-9, selected radio stations 2-10, films 2-11, and television 2-12. The fields may be dynamic, showing the most important content of the field 2, or they may be static and display only their function.

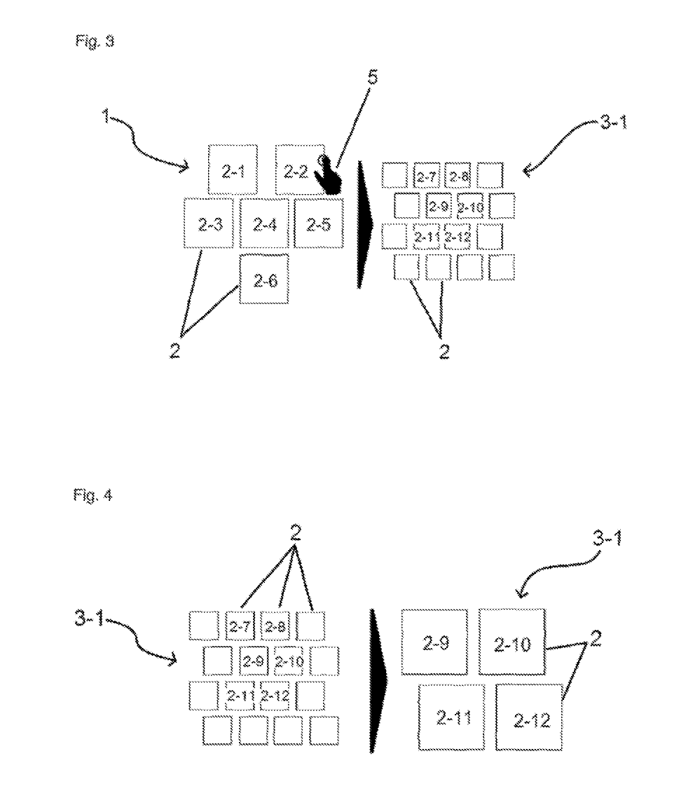

By means of another zoom gesture, the menu structure and thus the fields 2 can be enlarged, as shown in FIG. 4. Enlarging the fields 2 allows additional information to be displayed in the field 2. For instance, the field 2 for radio 2-9 can additionally display information about the radio station, the current performer, and the music title, the field 2 film 2-11 can display information about the film, such as the duration and the title of the film, and the field 2 television 2-12 can display information about the program as well as a scaled-down view of the program.

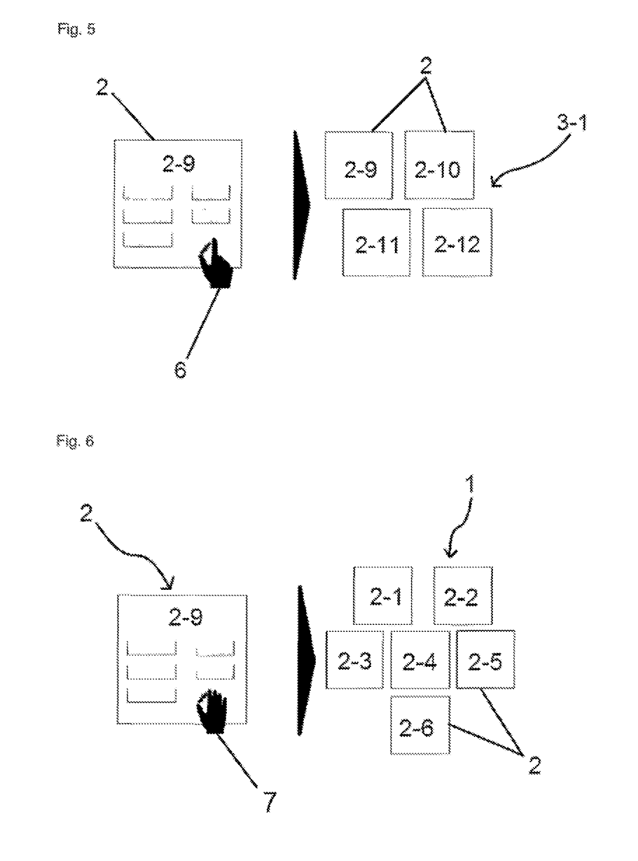

By a zooming-out motion 6, for example out of the field 2 radio 2-9, the user returns to the next higher plane 3-1, as represented in FIG. 5.

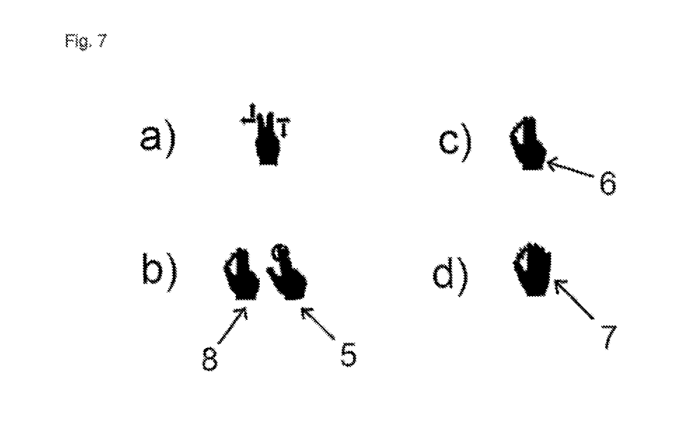

But it is also possible, as shown in FIG. 6, to return directly to the principal plane 1 by a closing gesture 7, for example, by touching the touchscreen or the touchpad with all the fingertips and by a zooming-out motion 6.

Depending on the degree of detail of the zoom level, only certain information is displayed for each application. Thus, the so-called “orbiting” of certain areas around others is omitted. Instead, all areas can be accessed via a shifting of the menu structure within a (zoom) plane 3. In addition, the multifunctional operating device provides different gestures for navigating inside and outside of an application. The navigation elements outside of an application, such as zooming, moving or clicking, are carried out by multi-finger gestures. The navigation and interaction with an application, on the other hand, is carried out using single-finger gestures, apart from zooming within the planes 3 with two fingers, or when navigating outside of the application with three fingers. Thus it is also possible, at any time and at any point of the user interface, to zoom out further using a three-finger gesture. By means of the closing gesture 7, in the form of a five-finger gesture, the user reaches the uppermost plane, that is to say the principal plane 1.

In FIG. 7, various diagrammatic representations of hand gestures in the form of navigation gestures are shown, which are suitable for navigating between the planes 3 and the individual fields 2 of the multifunctional operating device.

FIG. 7a shows the diagrammatic representation of a gesture that is carried out with two extended fingers and in which a swiping motion is performed with the fingertips on the touchscreen or on the touchpad, in order to shift the fields 2 within a plane 3. By means of this gesture, the fields 2 of a menu structure can be shifted vertically and horizontally within a plane 3.

FIG. 7b shows, on the left side, a zooming-in motion 8, in which two fingers such as, for example, the thumb and the index finger, are moved away from one another. The gesture of the zooming-in motion 8, exactly like the clicking gesture 5 shown on the right side of FIG. 7b, enables a switch into the next lower-level plane 3-1.

FIG. 7c shows a diagrammatic representation of a zooming-out motion 6, in which the fingertips of two fingers such as, for example, the thumb and the index finger, are moved towards one another on the touchscreen or on the touchpad. The gesture of the zooming-out motion 6 is used to reach the next higher plane 3 from a lower-level plane 3-1.

FIG. 7d shows a diagrammatic representation of a closing gesture 7, in which the fingertips of the whole hand are placed on the touchscreen or on the touchpad, and two fingers, for example the thumb and the index finger, are moved towards one another. The closing gesture 7 is used to reach the principal plane 1 from any lower-level plane 3-1.

It is understood that other gestures may also be used for navigation within the menu structures. For example, by means of a three-finger gesture in which three fingertips are moved towards one another or away from one another, the menu structure outside of an application or outside of a field 2 can be enlarged or reduced.

### LIST OF REFERENCE NUMERALS

1 Principal plane, plane

2 Field

2-1 Vehicle information

2-2 Entertainment

2-3 Communication

2-4 Favorites

2-5 Information

2-6 Social networks

2-7 Images

2-8 Album

2-9 Radio

2-10 Selected radio station

2-11 Films

2-12 Television

3 Plane

3-1 Lower-level plane

4 Display unit

5 Representation of clicking

6 Representation of zooming-out motion (zoom out)

7 Representation of closing gesture

8 Representation of zooming-in motion (zoom in)

1. A multifunctional operating device comprising a display unit (4) for displaying a menu structure, having a touchscreen or having a touchpad, wherein, within the menu structure, fields (2) are defined, which can be selected by touching, and the fields (2) are associated with defined function groups or functions,
wherein
the menu structure has a plurality of planes (3), and in that, by means of a zooming-in motion (8) with at least two fingers on a field (2) in the menu structure, another plane (3) of the menu structure can be selected, and in that the previous plane (1, 3) can be reached by a zooming-out motion (6).

2. The operating device according to claim 1, the first menu structure forms a principal plane (1) having fields (2), wherein the fields (2) represent higher-level function areas or functions, and the other planes (3-1) are sub-planes that provide a selection or particular function areas or functions.

3. The operating device according to claim 2, wherein the principal plane (1) can be selected from any plane (3, 3-1) by means of a closing gesture (7) performed with fingers of the user or by selecting a function field.

4. The operating device according to that claim 1, wherein the fields (2) of the menu structure within a plane (3) can be shifted by moving a finger of the user on the surface of the display (4).

5. A method for operating a multifunctional operating device comprising a display unit (4) for displaying a menu structure, having a touchscreen or having a touchpad, wherein, within the menu structure, fields (2) are defined, which are selected by touching, wherein defined function groups or functions are associated with the fields (2), and the menu structure has a plurality of planes (3),
wherein
a zooming-in motion (8) with at least two fingers on a field (2) in the menu structure, another plane (3) of the menu structure is opened, and by means of a zooming-out motion (6), the menu structure of the plane (3) is closed and the previous plane (1, 3) is reached.

6. The method according to claim 5, wherein in response to a defined closing gesture (7) that the user performs with fingers, or by the operation of a particular function field by the user, a switch takes place from any lower plane (3) of the menu structure into the principal plane (1) of the menu structure.

7. The method according to claim 5, wherein the multifunctional operation device is configured to operate electronic devices of a vehicle and to display vehicle parameters.

8. The method according to claim 7, wherein the electronic devices can be selected from the group comprising air conditioning apparatuses, infotainment systems, driver assistance systems, communication systems, and lighting systems.

9. The method according to claim 7, wherein the vehicle parameters can be selected from the group comprising vehicle speed, engine temperature, rotational speed of the engine, settings of an infotainment apparatus, oil level, and odometer reading.
